(19) United States
(12) Patent Application Publication
(10) Pub. No.: US 2006/0266793 A1
(43) Pub. Date: Nov. 30, 2006

(54) Purging system having workpiece movement device

(75) Inventors: Kent Bates, Chillicothe, IL (US); Gary D. Keil, Hanna City, IL (US); Jiubo Ma, Dunlap, IL (US)

Correspondence Address: CATERPILLAR/FINNEGAN, HENDERSON, L.L.P., 901 New York Avenue, NW, WASHINGTON, DC, 20001-4413, US

(73) Assignee: Caterpillar Inc.

(21) Appl. No.: 11/135,333

(22) Filed: May 24, 2005

(51) Int. Cl. B23K 20/14; B23K 1/00

(52) U.S. Cl. 228/42

(57) ABSTRACT

The purging device has a supply of purge gas and a gas delivery system. The gas delivery system is configured to produce a directed flow of purge gas from the supply, toward a workpiece. The purging device also has a movement system configured to generate relative movement between the workpiece and the directed flow of purge gas.

### TECHNICAL FIELD

The present disclosure is directed to a purging system, and more particularly, to a purging system having a workpiece movement device.

### BACKGROUND

Metal joining processes, such as brazing, typically require heating of base metal components to an elevated temperature that is lower than the base metal's melting point. Filler material may then be brought into contact with the heated base metal components, where it melts and is subsequently drawn through spaces between the base metal components, thereby forming a brazed workpiece.

Metal joining processes can be adversely affected by the presence of oxygen during heating. For example, an oxide layer can form on a surface of the base metal components, which can adversely affect the brazing process by altering properties of the base metal. To minimize these adverse affects,. manufacturers have developed methods and devices (e.g., purging devices) for reducing oxygen exposure to the base metal prior to the application of heat described above.

One such purging device is described in U.S. Pat. No. 6,508,976 (“the '976 patent”), issued to Till on Jan. 21, 2003. The '976 patent describes a purging device that supplies a purge gas in at least a partially liquefied form to a chamber. When introduced to the chamber, the liquefied portion of the gas undergoes a large volumetric expansion upon transition from liquid to gas. To maintain the pressure and atmospheric conditions within the chamber, the chamber may be partially isolated from the ambient atmosphere. The purging system of the '976 patent includes a seal to isolate the chamber atmosphere from the ambient atmosphere outside the chamber, such that an artificial atmosphere within the chamber can be produced, maintained, and/or manipulated.

Although the purging device of the '976 patent may potentially reduce the effects of oxygen contamination, the seal used to maintain the chamber atmosphere in isolation from the ambient atmosphere may add complexity and cost to the purge device. Further, because the purging device of the '976 patent is designed to purge a chamber, it may be unsuitable for purging complex workpieces having, for example, air-trapping geometry that may be difficult to purge within a chamber-purging device. In addition, because the purging device of the '976 patent cannot focus on a specific region of a workpiece, the purging process may be inefficient.

The purging system of the present disclosure solves one or more of the problems set forth above.

### SUMMARY OF THE INVENTION

One aspect of the present disclosure is directed to a purging device. The purging device includes a supply of purge gas and a gas delivery system. The gas delivery system is configured to produce a directed flow of purge gas from the supply, toward a workpiece. The purging device also includes a movement system configured to generate relative movement between the workpiece and the directed flow of purge gas.

Another aspect of the present disclosure is directed to a method of purging a workpiece. The method includes guiding a directed flow of purge gas produced by a gas delivery system toward the workpiece. The method also includes generating relative movement between the workpiece and the gas delivery system.

### BRIEF DESCRIPTION OF THE DRAWINGS

FIG. 1 is a diagrammatic illustration of an exemplary disclosed metal joining system; and

FIG. 2A is a diagrammatic illustration of another exemplary disclosed metal joining system.

FIG. 2B is a cross-section of the metal joining system depicted in FIG. 2A.

### DETAILED DESCRIPTION

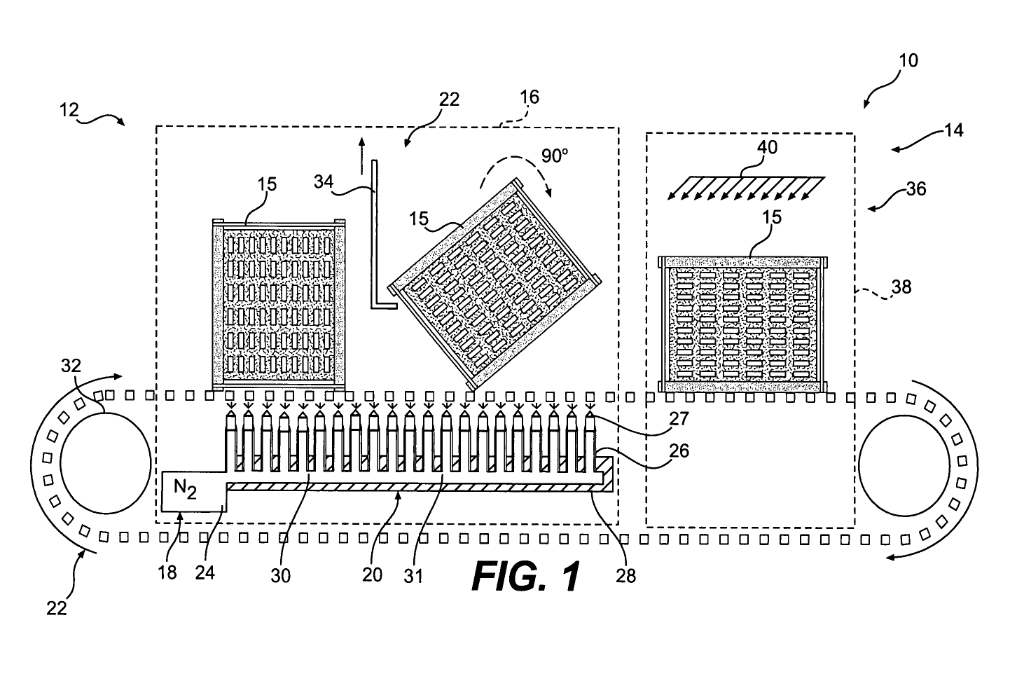

FIG. 1 illustrates an exemplary metal joining system 10 having a purging system 12 and a joining system 14. Metal joining system 10 may be configured to join components of similar or dissimilar metals, such as aluminum, copper, steel, or any other metal or alloy known in the art. The component may be moved through purging system 12 to joining system 14, where the components become a joined workpiece. For the purposes of this disclosure, a workpiece 15 may be defined as a workpiece component, a partially joined workpiece, or a joined workpiece. It is also contemplated that purging system 12 and metal joining system 14 may alternatively be a single integral system. It is further contemplated that joining system 14 may be omitted if desired, and purging system 12 may be used for other applications that do not involve metal joining, such as, for example industrial cleaning of workpiece 15.

Purging system 12 may include multiple components that cooperate to purge unwanted gas from workpiece 15. For the purpose of this disclosure, purging may be defined as the replacement of a portion or all of an unwanted gas from at least a region of workpiece 15. The unwanted gas may be a gas considered to adversely affect a joining process, such as, for example residual air. Purging system 12 may include a purge housing 16, a gas supply 18, a gas delivery system 20, and a movement system 22. It is contemplated that purge housing 16 may be omitted, if desired.

Purge housing 16 may be used to house and isolate the workpiece 15 during the purging process. In particular, purge housing 16 may include a generally enclosed structure having an inlet and an outlet (not shown) to allow purge gas to enter and unwanted gas or air to exit. Purge housing 16 may also include one or more openings (not shown) to allow workpiece 15 to enter and exit purge housing 16. Purge housing 16 may isolate workpiece 15 from ambient atmosphere to facilitate either purging or joining. For example, purge housing 16 may provide a predetermined pressure, temperature, humidity level, chemical content, or maintain any other condition within purge housing 16 known in the art to accomplish the desired task, such as facilitating joining of workpiece 15.

Gas supply 18 may include a reservoir 24 configured to hold purge gas in liquid form, gaseous form, or mixed liquid and gas form. In particular, reservoir 24 may be a pressure vessel located proximate to purge housing 16. The purge gas may be allowed to exit reservoir 24 and expand into purge housing 16 to force unwanted gas from workpiece 15. The purge gas may be an “inert gas” that reduces metal oxidation, such as, for example nitrogen, argon or any other suitable gas known in the art.

Gas delivery system 20 may include components that interact to produce a directed flow of purge gas from reservoir 24 toward workpiece 15. Specifically, gas delivery system 20 may include a gas delivery support 28 and one or more gas nozzles 26. It is contemplated that gas delivery system 20 may include additional or different components, such as, for example a regulator, a shutoff valve, or other delivery system devices known in the art. Gas delivery system 20 may be connected to gas supply 18 via a fluid passageway 30. Fluid passageway 30 may include a rigid conduit, a flexible conduit, or other suitable conduit for directing purge gas to gas delivery system 20. It is also contemplated that the directed flow of purge gas may be continuous or non-continuous.

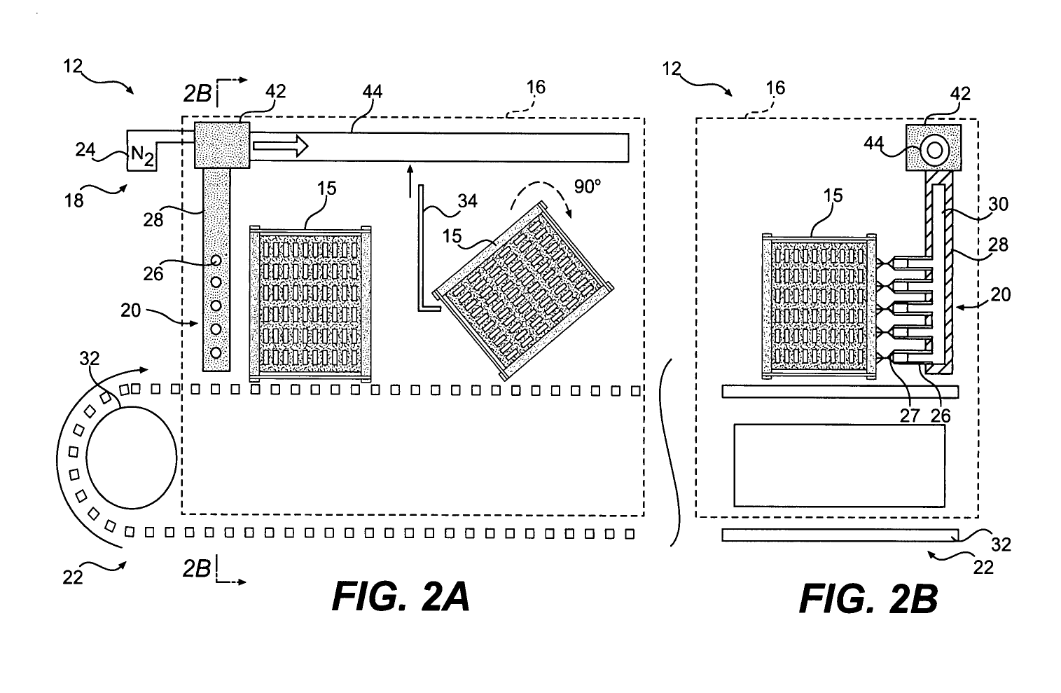

Gas nozzles 26 may be configured to focus the directed flow of purge gas toward workpiece 15. For example, gas nozzles 26 may include tapered, tubular structures configured to increase the flow efficiency of purge gas. The tapered structure of gas nozzles 26 may increase the pressure or velocity of the directed flow of gas. It is contemplated that gas nozzles 26 may have a structure other than tapered. The gas nozzle may contain one or more gas nozzle openings 27 through which the purge gas may flow. It is also contemplated that there may be a greater or lesser number of gas nozzles 26 than indicated in FIGS. 1 and 2. Gas nozzles 26 may be arranged in a linear array to direct purge gas flow toward a greater area of workpiece 15 than may be possible with a single gas nozzle 26. It is contemplated that gas nozzles 26 may, alternatively, be arranged in a planar array, or other suitable configuration, to increase the efficiency or effectiveness of the purging process. For example, gas nozzles 26 may be located at a plurality of locations surrounding workpiece 15. The flow of purge gas from gas nozzles 26 and/or the plurality of locations of gas nozzles 26 may be directed toward workpiece 15 simultaneously or sequentially.

Gas delivery support 28 may be configured to provide structural stability to gas nozzles 26. In particular, gas delivery support 28 may include one or more elements structurally interconnecting gas nozzles 26 and/or connecting gas nozzles 26 to purge housing 16. Gas delivery support 28 may provide a common internal manifold 31 for connecting fluid passageway 30 with gas nozzles 26.

Movement system 22 may include one or more movement devices configured to move workpiece 15 relative to the flow of purge gas during purging. For example, movement system 22 may include a first movement device 32 configured to linearly translate workpiece 15 and a second movement device 34 configured to orient workpiece 15. The first and second movement devices may be configured to translate and orient workpiece 15 at separate times or simultaneously. It is contemplated that first movement device 32 moves workpiece 15 before, during or after purging. First movement device 32 may, alternatively, be configured to translate workpiece 15 in a curvilinear direction. Second movement device 34 may be configured to orient workpiece 15 through an angle of about 90 degrees. First movement device 32 and second movement device 34 may be combined into an integral movement device capable of translating and orienting workpiece 15. Movement system 22 may be automatically or manually controlled, and may move workpiece 15 continuously or non-continuously.

First movement device 32 may be located between gas delivery system 20 and workpiece 15. The movement device may be configured to allow the flow of purge gas through the movement device. For example, first movement device 32 may include a conveyer belt, rollers or other suitable movement devices. Alternatively, movement device 32 may be located other than between gas delivery system 20 and workpiece 15.

Second movement device 34 may be configured to alter the orientation of workpiece 15 during purging. For example, second movement device 34 may include a lever, hoist, robotic arm, or any other suitable movement device. It is contemplated that second movement device 34 may be configured to both linearly translate and orient workpiece 15. It is further contemplated that one of the first or second movement devices may be omitted, if desired.

Joining system 14 may be configured to join workpiece 15 through, for example, the application of heat. In particular, workpiece 15 may be joined through a brazing process, TIG welding process, MIG welding process, arc welding process, gas welding process, friction welding process, or any other metal joining process that could benefit from a purging step. For example, after purging, workpiece 15 may be heated and brought together. A filler material may be used to join workpiece 15 following the purging of unwanted gas from workpiece 15. It is contemplated that the filler material may be omitted, if desired. It is further contemplated that workpiece 15 may, alternatively, be brought together prior to heating. Metal joining system 10 may include a furnace 36 to apply the heat to workpiece 15 during the joining process.

Furnace 36 may house and facilitate the joining process. In particular, furnace 36 may include a furnace housing 38 and a heat source 40. It is contemplated that furnace 36 may further include other components such as, for example, a quenching device (not shown) to cool workpiece 15. Second movement device 34 may extend into or through furnace 36 to facilitate movement of workpiece 15 from purging system to joining system. It is further contemplated that if purging system 12 and joining system 14 are integral, gas nozzles 26 and/or movement system 22 may be located within furnace 36.

Furnace housing 38 may be configured to isolate workpiece 15 during joining. In particular, furnace housing 38 may include a generally enclosed structure having one or more openings (not shown) to allow workpiece 15 to enter and/or exit furnace housing 38. In metal joining systems having an integral furnace 36 and purging system 12, furnace housing 38 may have an inlet and outlet (not shown) to allow purge gas to enter and unwanted gas or air to exit. Furnace housing 38 may isolate workpiece 15 from the ambient atmosphere to facilitate either joining and/or purging. For example furnace housing 38 may be configured to provide a predetermined temperature, pressure, humidity level, and/or chemical content inside furnace housing 38.

Heat source 40 may be configured to apply heat to workpiece 15. Heat source 40 may utilize electric-conducting elements, flame-propagating elements, friction-forming elements, or any other suitable type of heat-generating elements. It is contemplated that the application of heat may be through a manual or automated process.

FIG. 2A illustrates another embodiment of purging system 12 illustrated in FIG. 1. Similar to FIG. 1, FIG. 2A includes purge housing 16, gas supply 18, and movement system 22. However in contrast to FIG. 1, gas delivery system 20 of FIG. 2A may be mobile. In this manner, gas delivery system 20 may include mobile gas nozzles 26 to focus the directed flow of purge gas towards workpiece 15. Alternatively, workpiece 15 may move relative to the stationary gas nozzles 26, or workpiece 15 and gas nozzles 26 may move simultaneously. In particular, gas nozzles 26 may be connected to a drive 42 that moves along a guide rail 44. In this embodiment, fluid passageway 30 may be constructed of flexible material to accommodate movement of gas nozzles 26.

FIG. 2B illustrates a cross-section of purging system 12 depicted in FIG. 2A. FIG. 2B illustrates a cross-section of purge housing 16, gas delivery system 20, gas nozzles 26, and workpiece 15. In particular, FIG. 2B illustrates the directed flow of purge gas focused by gas nozzles 26 toward workpiece 15.

Drive 42 may be configured to engage guide rail 44 for movement along guide rail 44. Specifically, drive 42 may move gas nozzles 26 from one end of workpiece 15 to the other end of workpiece 15, or may concentrate on a particular region of workpiece 15 during the purging process. For example, drive 42 may include any device for moving gas nozzles 26 along guide rail 44, such as a worm gear, pneumatic motor, electric motor, hydraulic actuator, or any other suitable device. In the situation where drive 42 includes a pneumatic motor, a portion of gas supply 18 may be diverted to supply the pneumatic motor. It is contemplated that drive 42 maybe manually or automatically controlled to move gas nozzles 26 in any desired purging pattern.

Guide rail 44 may extend from one end of purge housing 16 to the other end of purge housing 16 to assist movement of gas nozzles 26. Guide rail 44 may be connected to the purge or furnace housing 38, and may have a trajectory designed to facilitate purging. In particular, the trajectory of guide rail 44 may be designed to increase the efficiency of the purging process, and may be linear or curvilinear. It is contemplated that guide rail 44 may have gear teeth, notches, grooves, a chain element or any other elements to facilitate the movement of gas nozzles 26 along guide rail 44.

### INDUSTRIAL APPLICABILITY

The purge system of the disclosed application may be applicable to a wide range of industrial processes. Although intended for use with metal joining systems, purging system 12 may also be used for cleaning or other industrial processes that may benefit from the purging of a workpiece. The replacement of unwanted gas from the workpiece may improve the quality of the resultant joint. The operation of the metal joining system 10 will now be explained.

Workpiece 15 may proceed through purging system 12 before moving into joining system 14. For example, workpiece 15 may be loaded onto first movement device 32 for movement into purge housing 16. Inside purge housing 16, gas may flow from gas supply 18 through fluid passageway 30 to gas nozzles 26. Gas nozzles 26 may focus the directed gas flow toward workpiece 15 during relative movement between gas nozzles 26 and workpiece 15. Workpiece 15 may move relative to gas nozzles 26, gas nozzles 26 may move relative to workpiece 15, or both may move (see FIG. 2).

The directed flow of purge gas toward the workpiece 15 may move the unwanted gas trapped within workpiece 15. The relative movement between workpiece 15 and/or gas nozzles 26 during the purging process may generate changes in the flow of purge gas relative to workpiece 15. Unwanted gas trapped within the complex geometry of workpiece 15 may be replaced with the purge gas due to the force applied to the unwanted trapped gas by the changing flow of purge gas.

Following the purging process, workpiece 15 may be moved from purge housing 16 into furnace housing 38. Heat source 40 may then apply heat to workpiece 15 before or after the application of filler material to workpiece 15. It is contemplated that workpiece 15 may be partially heated in purging system 12, and/or returned to purging system 12 after the joining process for cooling of the joined workpiece by flow of purge gas.

The efficiency of the purging process may be increased because purging system 12 may reduce purging time compared to existing purge systems. Specifically, the purging time may be reduced as it typically takes less time to purge workpiece 15 than purging an entire chamber. The efficiency of the purging process may be further increased by purging only desired regions of workpiece 15, thereby reducing the volume of unwanted gas moved during the purging process. In particular, costs may be saved because less time and less purge gas may be required to adequately purge workpiece 15.

It will be apparent to those skilled in the art that various modifications and variations can be made to the purging system of the present disclosure without departing from the scope of the disclosure. Other embodiments will be apparent to those skilled in the art from consideration of the specification and practice of the purging system disclosed herein. It is intended that the specification and examples be considered as exemplary only, with a true scope of the disclosure being indicated by the following claims and their equivalents.

What is claimed is:

1. A purging device, comprising:
a supply of purge gas;
a gas delivery system configured to produce a directed flow of purge gas from the supply toward a workpiece; and
a movement system configured to generate relative movement between the workpiece and the directed flow of purge gas.

2. The purging device of claim 1, wherein the movement system is configured to translate the workpiece relative to the directed flow of purge gas.

3. The purging device of claim 1, wherein the gas delivery system includes at least one gas nozzle to focus the directed flow of purge gas toward the workpiece.

4. The purging device of claim 3, wherein the gas delivery system is configured to move at least one gas nozzle relative to the workpiece.

5. The purging device of claim 4, wherein at least one gas nozzle and the workpiece are configured to move simultaneously.

6. The purging device of claim 1, wherein the purge gas includes an inert gas.

7. The purging device of claim 6, wherein the inert gas includes nitrogen.

8. The purging device of claim 2, wherein the movement system is configured to rotate the workpiece through approximately 90 degrees.

9. A method of purging a workpiece, comprising:
guiding a directed flow of purge gas produced by a gas delivery system toward the workpiece; and
generating relative movement between the workpiece and the gas delivery system.

10. The method of claim 9, wherein generating relative movement includes moving the workpiece.

11. The method of claim 10, wherein the relative movement includes translation.

12. The method of claim 10, wherein the relative movement includes rotation.

13. The method of claim 12, wherein the rotation occurs over about 90°.

14. The method of claim 10, wherein generating relative movement includes moving the gas delivery system.

15. The method of claim 14, wherein generating relative movement includes moving the gas delivery system and workpiece simultaneously.

16. The method of claim 9, wherein the gas is an inert gas.

17. The method of claim 16, wherein the inert gas is nitrogen.

18. A metal joining system, comprising:
a furnace configured to heat a workpiece; and
a purging device, including:
a supply of purge gas;
a gas delivery system configured to produce a directed flow of purge gas from the supply toward the workpiece; and
a movement system configured to generate relative movement between the workpiece and the directed flow of purge gas.

19. The metal joining system of claim 18, wherein the movement system is configured to translate the workpiece relative to the directed flow of purge gas.

20. The metal joining system of claim 18, wherein the gas delivery system includes at least one gas nozzle to focus the directed flow of purge gas toward the workpiece.

21. The metal joining system of claim 20, wherein the gas delivery system is configured to move at least one gas nozzle relative to the workpiece.

22. The metal joining system of claim 21, wherein at least one gas nozzle and the workpiece are configured to move simultaneously.

23. The metal joining system of claim 18, wherein the purge gas includes an inert gas.

24. The metal joining system of claim 23, wherein the inert gas includes nitrogen.

25. The metal joining system of claim 18, wherein the movement system is configured to rotate the workpiece through approximately 90 degrees.
